(19) United States
(12) Patent Application Publication
(10) Pub. No.: US 2020/0115050 A1
(43) Pub. Date: Apr. 16, 2020

(54) CONTROL DEVICE, CONTROL METHOD, AND PROGRAM

(71) Applicant: Sony Corporation, Tokyo (JP)

(72) Inventor: Sho MURAKOSHI, Tokyo (JP)

(73) Assignee: Sony Corporation, Tokyo (JP)

(21) Appl. No.: 16/612,406

(22) PCT Filed: Mar. 2, 2018
(86) PCT No.: PCT/JP2018/007992

§ 371 Date: Nov. 11, 2019

(30) Foreign Application Priority Data
May 18, 2017 (JP) 2017-098643

(51) Int. Cl. B64C 39/02; G06K 9/00

(52) U.S. Cl. CPC B64C 39/024; G06K 9/00637; B64C 2201/148; B64C 2201/145; B64C 2201/123

(57) ABSTRACT

To enable control of a flight of a UAV more appropriately.

There is provided a control device including: an identification unit that identifies a sign installed on the ground on the basis of information acquired by a UAV; and a control unit that controls the flight of the UAV in accordance with the identification.

### TECHNICAL FIELD

The present disclosure relates to a control device, a control method, and a program.

### BACKGROUND ART

Recently, systems, services, or the like using an unmanned aerial vehicle (UAV) have been actively developed. For example, Patent Document 1 below discloses a technique to perform various surveys by installing a ground control point and creating a three-dimensional model of the ground on the basis of an orientation point at which the ground control point that appears in a captured image obtained by capturing the ground control point is installed.

In these systems, services, or the like, there are various methods of controlling the flight of the UAV. Examples of such methods include a method of controlling the flight of the UAV to pass a plurality of target pass points designated on a flight path, each of the target pass points (also referred to as “waypoint”) being a three-dimensional area having a predetermined size and shape (for example, a spherical shape). In the method, for example, the UAV controls the flight of the own device so as to determine location information of the own device on the basis of a global navigation satellite system (GNSS) signal received by a GNSS receiver mounted on the own device and to pass the target pass point by using the location information.

### CITATION LIST

### Patent Document

Patent Document 1: Japanese Patent Application Laid-Open No. 2005-140550

### SUMMARY OF THE INVENTION

### Problems to be Solved by the Invention

However, depending on the method, the flight of the UAV cannot be properly controlled in some cases. For example, the location information of the UAV determined on the basis of the GNSS signal is not stable, and a fluctuation of several tens [cm] or several [m] occurs in the location information in some cases. Furthermore, the UAV cannot pass the target pass point in some cases due to the influence of wind or settings of the target pass point (for example, in a case where the target pass point is small (target pass range is narrow), a case where each target pass point is set such that a turn exceeding turning performance of the UAV is required, or the like). This will cause the UAV to make a retry until the UAV passes the target pass point, and there is a possibility of increased flight time of the UAV or making a dangerous flight.

Therefore, the present disclosure has been made in view of the above, and the present disclosure provides a novel, improved control device, a control method, and a program that can control the flight of the UAV more appropriately.

### Solutions to Problems

The present disclosure provides a control device including: an identification unit that identifies a sign installed on the ground on the basis of information acquired by a UAV; and a control unit that controls flight of the UAV in accordance with the identification.

Furthermore, the present disclosure provides a control method to be executed by a computer, the control method including: performing identification of a sign installed on a ground on the basis of information acquired by a UAV; and performing control of flight of the UAV in accordance with the identification.

Furthermore, the present disclosure provides a program for causing a computer to execute: performing identification of a sign installed on a ground on the basis of information acquired by a UAV; and performing control of flight of the UAV in accordance with the identification.

### Effects of the Invention

As described above, the present disclosure makes it possible to control the flight of the UAV more appropriately.

Note that above effects are not necessarily restrictive, and in addition to or instead of the above effects, any of the effects indicated in the present specification or other effects that can be determined from the present specification may be produced.

### BRIEF DESCRIPTION OF DRAWINGS

FIG. 1 is a diagram showing one example of a flight control method of a UAV by designating target pass points.

FIG. 2 is a diagram showing one example of a configuration of a control system according to the present embodiment.

FIG. 3 is a block diagram showing one example of a functional configuration of the UAV according to the present embodiment.

FIG. 4 is a block diagram showing one example of a functional configuration of a ground control point according to the present embodiment.

FIG. 5 is a block diagram showing one example of a functional configuration of an air-traffic control device according to the present embodiment.

FIG. 6 is a flowchart showing one example of flight control of the UAV based on identification of the ground control point.

FIG. 7 is a flowchart showing one example of the flight control of the UAV in a case where the ground control point functions as the target pass point.

FIG. 8 is a flowchart showing one example of the flight control of the UAV near the ground surface.

FIG. 9 is a diagram showing a hardware configuration of an information processing device that embodies the UAV, the ground control point, or the air-traffic control device according to the present embodiment.

### MODE FOR CARRYING OUT THE INVENTION

A preferred embodiment of the present disclosure will be described in detail below with reference to the accompanying drawings. Note that in the present specification and the drawings, components having substantially the same functional configuration are denoted with the same reference symbol, and redundant description thereof will be omitted.

Note that the description will be made in the following order.

### 1. BACKGROUND

2. Overview of the present embodiment
3. Functional configuration of the devices
4. Operation of the devices
5. Hardware configuration
6. Conclusion

### 1. BACKGROUND

Recently, systems, services, or the like using a UAV have been actively developed, and in these systems, services, or the like, there are various methods of controlling the flight of the UAV. Examples of such methods include a method of controlling the flight of the UAV to pass a plurality of target pass points (target pass ranges) designated on a flight path as described above.

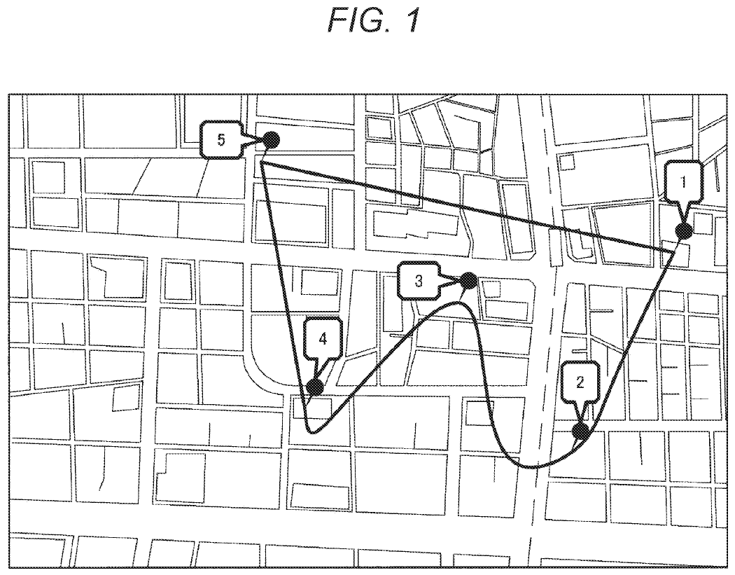

Here, with reference to FIG. 1, the flight control method of the UAV by designating the target pass points will be described. FIG. 1 is a diagram showing one example of the flight control method of the UAV by designating the target pass points.

For example, in a case where a user designates target pass points by using a predetermined information processing terminal, as shown in FIG. 1, a method by which the user designates horizontal locations of the target pass points and order to pass can be considered for a captured image captured from the sky above a flight area of the UAV or a map image (FIG. 1 shows the order to pass by the numbers 1 to 5). Moreover, the target pass points are set by the user adding altitude information to the designated horizontal locations. Note that this designation method is merely one example, and the method of designating the target pass points is arbitrary.

However, depending on the method, the flight of the UAV cannot be properly controlled in some cases.

For example, the location information of the UAV determined on the basis of the GNSS signal is not stable, and a fluctuation of several tens [cm] or several [m] occurs in the location information in some cases. Therefore, when the UAV is flying (floating) near the ground surface, especially immediately after takeoff or immediately before landing, an attitude of the UAV may be unstable. More specifically, in a case where the UAV controls the flight of the own device while comparing the location information of the ground surface with the location information of the own device, no fluctuation occurs in the location information of the ground surface and a fluctuation occurs only in the location information of the own device. Therefore, the flight of the UAV (attitude or the like) becomes unstable in accordance with the fluctuation. This increases the risk of, for example, the UAV flying (floating) near the ground surface losing balance to crash or colliding with facilities or a person.

Furthermore, the UAV cannot pass the target pass points in some cases due to the influence of wind or settings of the target pass points. For example, in a case where the target pass points are small (target pass ranges are narrow), in a case where each target pass point is set such that a turn exceeding turning performance of the UAV is required, or the like, the possibility that the UAV cannot pass the target pass points increases.

Furthermore, in a case where the UAV is set to make a retry until the UAV can pass the target pass points, flight time of the UAV increases, or there is a higher risk that an accident may occur by the UAV performing a sudden action (sudden turn, sudden rise, sudden fall, or the like) in order to pass the target pass points. In particular, in a case where an flight operation in a case where the UAV cannot pass the target pass points is not set in detail, since it is difficult for the user to predict the behavior of the UAV, even if an accident does not occur, for example, a case where the UAV passes a passage prohibited airspace or the like may also occur.

The person who has disclosed the present disclosure has conceived the present technology in view of the above circumstances. A control device, a control method, and a program according to the present disclosure identify a ground control point installed on the ground on the basis of information acquired by the UAV and control the flight of the UAV in accordance with a result of the identification. For example, the control device, the control method, and the program according to the present disclosure identify a ground control point in a captured image by analyzing the captured image acquired by the UAV and perform flight control corresponding to the identified ground control point on the UAV. This allows the control device, the control method, and the program according to the present disclosure to control the flight of the UAV more appropriately. The following will describe in more detail one embodiment of the present disclosure.

### 2. OVERVIEW OF THE PRESENT EMBODIMENT

First, an overview of the present embodiment will be described.

The present disclosure can be used in various systems, devices, or the like. For example, the present disclosure can be used in logistics systems, land survey systems, automated flight systems, or the like that use the UAV. In this document, as one example, a description is given assuming that the present disclosure is used in a logistics system. More specifically, in the logistics system in which the UAV transports an arbitrary article, a description is given assuming that the flight of the UAV is controlled by the technique of the present disclosure.

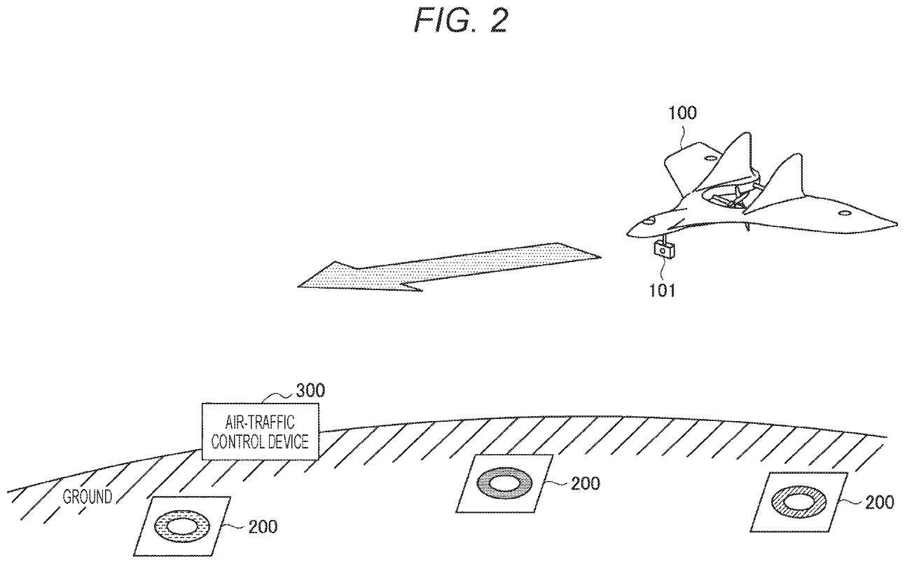

Here, with reference to FIG. 2, a configuration of a control system according to the present embodiment will be described. FIG. 2 is a diagram showing one example of the configuration of the control system according to the present embodiment.

As shown in FIG. 2, the control system according to the present embodiment includes a UAV 100, ground control points 200, and an air-traffic control device 300. Furthermore, a camera (image capturing device) 101 is mounted on the UAV 100.

(Ground Control Point 200)

The ground control point 200 is a sign used for flight control of the UAV 100 in the control system according to the present embodiment. More specifically, the ground control point 200 is installed on the ground surface near an area where the UAV 100 flies, and the UAV 100 detects and identifies the ground control point 200 during flight, and controls the flight of the own device on the basis of a result of the identification.

In the present embodiment, various types of ground control point 200 with different appearances (shape and/or color, or the like) are used, and identification information (hereinafter referred to as “ID” for convenience) is assigned to each type of the ground control point 200. Here, the shape of the ground control point 200 (or a mark attached to the ground control point 200) is arbitrary. For example, the shape of the ground control point 200 may be various shapes such as a round shape, a square shape, a triangular shape, or a double circle shape, or a combination of these shapes. Furthermore, the color of the ground control point 200 (or a mark attached to the ground control point 200) is also arbitrary. For example, the color of the ground control point 200 may be any color such as red, blue, yellow, green, or black, or may be a combination of these colors. This allows the UAV 100 to identify the ground control point 200 detected from the captured image on the basis of the appearance (shape and/or color, or the like). Note that the above description is merely one example, and the appearance of the ground control point 200 is not particularly limited if the UAV 100 can identify the ground control point 200. For example, if the UAV 100 can identify the ground control point 200 by performing wireless communication with the ground control point 200 or other methods, the appearance of the ground control point 200 may be identical to each other.

Then, information for controlling the flight of the UAV 100 (hereinafter referred to as “control information” for convenience) is associated with each ID of the ground control point 200. Contents of the control information associated with each ID of the ground control point 200 are arbitrary. For example, the control information may be a flight operation such as “takeoff”, “landing”, “speed up”, “speed down”, “turn right”, “turn left”, “rise”, or “fall”. The control information may be a flight operation numerically designated in more detail, such as “rise by 50 [m]”, “speed up to 60 [m/s]”, or [turn right 100 [m] ahead].

Furthermore, the control information may be designated in more detail with the captured image or the like, such as “perform flight control such that the ground control point 200 appears with a predetermined size in a predetermined area of the captured image (for example, approximately at the center of the captured image).” Furthermore, the control information may be information indicating a virtual geographical boundary. (This virtual geographical boundary is also called “geofence”. The geofence is, for example, a geographical boundary or the like that indicates a closed space defined on a geographical area, such as a passage prohibited airspace.) Furthermore, the control information may be contents of control other than the flight of the UAV 100, such as “start capturing” or “end capturing.” Note that a plurality of pieces of control information may be associated with one ground control point 200.

Furthermore, information regarding priority (and/or urgency) of a flight operation may be attached to the control information. Information regarding priority may be attached to the control information, for example, in a case where a predetermined flight operation is required near a dangerous airspace (for example, in a case where the maximum flight altitude is designated, in a case where the maximum flight speed is designated, or the like), or in a case where it is required to leave the passage prohibited airspace immediately, or the like. This makes it possible to determine, for example, in a case where the UAV 100 detects a plurality of ground control points 200, which flight control should be prioritized, or the like.

Furthermore, the ground control point 200 may function as the target pass point. More specifically, the ground control point 200 may be installed on the ground surface below the planned flight route of the UAV 100, and the UAV 100 may determine that the UAV 100 has passed the target pass point by the UAV 100 detecting and identifying the ground control point 200 installed on the ground surface during flight. This increases the possibility that the UAV 100 can pass the target pass point. Details will be described later.

Furthermore, the ground control point 200 may include a GNSS receiver, and determine the location of the own device by receiving radio signals from a plurality of GNSS satellites with the GNSS receiver and using these signals to calculate a separation distance between each GNSS satellite and the receiver. This eliminates the need for a surveyor to go to an installation location of each ground control point 200 and to survey the position of the ground control point 200.

Moreover, the ground control point 200 may include a wireless communication function, and share, with an external device such as the UAV 100, the ID, location information, or the like of the own device by performing wireless communication with the external device.

Furthermore, by the ground control point 200 having a wireless communication function, the UAV 100 may detect and identify the ground control point 200 not by analyzing the captured image but by wireless communication with the ground control point 200. More specifically, by the strength of the radio signal emitted by the ground control point 200 being adjusted, in a case where wireless communication with the ground control point 200 is possible in a case where the separation distance to the ground control point 200 is within a predetermined distance, the UAV 100 can determine that the separation distance to the ground control point 200 is closer than the predetermined distance on the basis of success of wireless communication with the ground control point 200. In other words, the UAV 100 can control the flight of the own device in real time by detecting the ground control point 200 from the captured image during flight as described above. The UAV 100 can also control the flight of the own device in real time by detecting the ground control point 200 by wireless communication.

(UAV 100)

The UAV 100 is a flying body in the control system according to the present embodiment. The UAV 100 according to the present embodiment is required at least to have a basic flight function, and the type of UAV 100 is arbitrary. For example, the UAV 100 may be an aircraft-type flying body (vertical take-off and landing (VTOL), or the like), a helicopter-type flying body, a multicopter-type flying body, or the like. The VTOL has characteristics of both the aircraft type and the multicopter type. Note that the UAV 100 may be able to transport any article. Furthermore, the UAV 100 in the present embodiment may be not only an unmanned flying body, but also, for example, a flying body that transports a person (for example, a flying body that transports a person by automatic driving or semi-automatic driving or the like).

The UAV 100 according to the present embodiment performs a flight of specifications designated by the air-traffic control device 300 as described later. For example, the UAV 100 flies to pass the designated target pass point at the altitude and speed designated by the air-traffic control device 300. Note that the specification designated by the air-traffic control device 300 is not limited to these specifications, and may be changed as appropriate.

Furthermore, during flight, the UAV 100 according to the present embodiment detects and identifies the ground control point 200 installed on the ground surface by a predetermined method. For example, the UAV 100 includes a camera 101, and the camera 101 captures the ground control point 200 installed on the ground surface during flight of the UAV 100. Then, by analyzing the captured image, the UAV 100 detects and identifies the ground control point 200 in the captured image. Furthermore, the UAV 100 may detect and identify the ground control point 200 by performing wireless communication with the ground control point 200 and acquiring the ID or location information or the like of the ground control point 200.

Then, the UAV 100 controls the flight of the own device on the basis of the ID of the identified ground control point 200. For example, the UAV 100 performs the flight operation associated with the ID of the ground control point 200. This allows the UAV 100 to control the flight autonomously and in real time without a user operation.

Furthermore, as described above, the ground control point 200 may function as the target pass point. For example, the UAV 100 may fly by using the target pass point designated in advance by the air-traffic control device 300 as a landmark, and in a case where the ground control point 200 that functions as the designated target pass point is detected and identified, it may be determined that the UAV 100 has passed the target pass point. This increases the possibility that the UAV 100 can pass the target pass point. More specifically, the UAV cannot pass the target pass point in some cases due to the influence of wind or settings of the target pass point by the air-traffic control device 300 (in a case where the target pass point is small, in a case where each target pass point is set such that a turn exceeding turning performance of the UAV 100 is required, or the like). However, the UAV 100 detects and identifies the ground control point 200 by the captured image or wireless communication, and sets the identified ground control point 200 as the target pass point, thereby making it possible to reduce the possibility of being unable to pass the target pass point due to the influence of wind, the setting of the target pass point by the air-traffic control device 300, or the like. This allows the UAV 100 according to the present embodiment to shorten the flight time, to suppress the occurrence of an accident caused by the UAV's sudden behavior (sudden turn, sudden rise, sudden drop, or the like) in order to pass the target pass point, or the like, or to suppress that the UAV passes the passage prohibited airspace or the like.

Furthermore, when flying (floating) near the ground surface (for example, immediately after takeoff or immediately before landing), the UAV 100 can implement stable flight by performing control using ground location information of the identified ground control point 200. For example, the UAV 100 detects and identifies the ground control point 200 installed at the takeoff point or landing point with the captured image or by wireless communication as described above, and acquires the ground location information of the ground control point 200. Then, the UAV 100 corrects the location information of the own device by changing a weight of each of the ground location information of the ground control point 200 and the location information of the own device obtained by the GNSS receiver mounted on the own device in accordance with flight altitude.

More specifically, as the altitude decreases, the UAV 100 increases the weight of the ground location information of the ground control point 200 (decreases the weight of the location information of the own device obtained by the GNSS receiver mounted on the own device). As the altitude increases, the UAV 100 decreases the weight of the ground location information of the ground control point 200 (increases the weight of the location information of the own device obtained by the GNSS receiver mounted on the own device). With this control, even when the UAV 100 is flying (floating) near the ground surface, the flight of the UAV 100 (attitude or the like) becomes stable because the fluctuation of the location information of the own device becomes smaller.

(Air-Traffic Control Device 300)

The air-traffic control device 300 is an information processing device that manages the control system according to the present embodiment. The air-traffic control device 300 is implemented by a device having a communication function such as a personal computer (PC), a tablet, or a smartphone executing a predetermined program.

The air-traffic control device 300 according to the present embodiment is operated by a user who manages the control system. The user sets various pieces of information used for the flight of the UAV 100 (information regarding the speed or altitude of the UAV 100, the target pass point, or the like) by using the air-traffic control device 300. Note that these functions are merely one example, and the function of the air-traffic control device 300 can be changed as needed. For example, the air-traffic control device 300 may be able to change the control information associated with the ID of the ground control point 200. In a case where the ground control point 200 is displayed electronically, the air-traffic control device 300 may be able to change the display of the ground control point 200. This allows the air-traffic control device 300 to flexibly change the flight control of the UAV 100 without replacing the ground control point 200.

Furthermore, the air-traffic control device 300 has a wireless communication function. By performing wireless communication with an external device such as the UAV 100 or the ground control point 200, the air-traffic control device 300 shares the above-described settings or the like with the external device such as the UAV 100 or the ground control point 200.

Note that the control system according to the present embodiment may have a cloud server (not shown), and the cloud server and the UAV 100 may perform wireless communication. In other words, the control system may include the UAV 100, the ground control point 200, the air-traffic control device 300, and the cloud server. Furthermore, the cloud server may acquire the captured image from the camera 101 of the UAV 100, detect and identify the ground control point instead of the UAV 100, and transmit the identification result to the UAV 100 by wireless communication.

### 3. FUNCTIONAL CONFIGURATION OF THE DEVICES

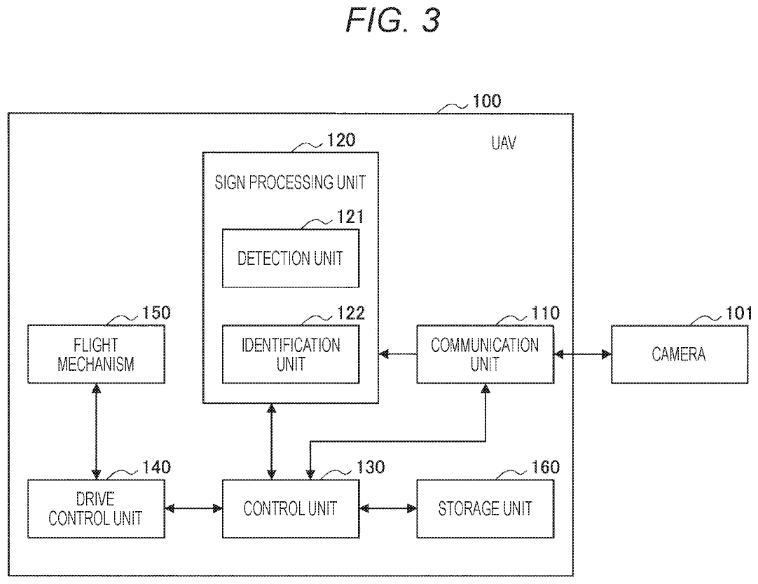

The overview of the present embodiment has been described above. Subsequently, with reference to FIGS. 3 to 5, the functional configuration of each device according to the present embodiment will be described.

(Functional Configuration of the UAV 100)

First, with reference to FIG. 3, the functional configuration of the UAV 100 according to the present embodiment will be described. FIG. 3 is a block diagram showing one example of the functional configuration of the UAV 100 according to the present embodiment.

As shown in FIG. 3, the UAV 100 according to the present embodiment includes a communication unit 110, a sign processing unit 120, a control unit 130, a drive control unit 140, a flight mechanism 150, and a storage unit 160. Furthermore, the sign processing unit 120 includes a detection unit 121 and an identification unit 122. The following describes each functional configuration.

(Communication Unit 110)

The communication unit 110 has a functional configuration to communicate with an external device such as the camera 101, the ground control point 200, or the air-traffic control device 300. More specifically, the communication unit 110 receives captured image data by performing communication (wireless communication and/or wired communication) with the camera 101. Furthermore, the communication unit 110 receives the ID and location information of the ground control point 200 by performing wireless communication with the ground control point 200. Furthermore, the communication unit 110 receives various pieces of setting information used for the flight of the UAV 100 (information regarding the speed setting or altitude setting of the UAV 100, the target pass point, or the like) by performing wireless communication with the air-traffic control device 300, or transmits information regarding a flight status of the own device to the air-traffic control device 300. Note that the above communication is merely one example, and contents of the communication may be changed as appropriate. The communication unit 110 provides the received information to the sign processing unit 120 or the control unit 130 as described later.

(Sign Processing Unit 120)

The sign processing unit 120 performs processing on the ground control point 200. More specifically, the sign processing unit 120 includes the detection unit 121 and the identification unit 122, and performs detection, identification, or the like of the ground control point 200 by controlling these configurations. The detection unit 121 and the identification unit 122 will be described below.

(Detection Unit 121)

The detection unit 121 detects the ground control point 200. For example, the detection unit 121 detects the captured ground control point 200 by analyzing captured image data captured by the camera 101. A method of the analysis is arbitrary. For example, the detection unit 121 may detect the ground control point 200 from the captured image by performing, on the captured image data, binarization processing of pixels of the captured image, erosion processing, dilation processing (expansion processing), contour detection processing for detecting a contour of pixels estimated to be the ground control point 200, extraction processing of a rectangle circumscribing the contour, extraction processing of an area where the ground control point 200 is expected to be captured (also referred to as a candidate area), feature quantity extraction processing of the candidate area, or the like.

Note that as described above, the detection unit 121 may detect the ground control point 200 on the basis of the successful wireless communication with the ground control point 200. The detection unit 121 provides information regarding the detected ground control point 200 (for example, information regarding a feature of the ground control point 200 in the captured image, information included in a wireless signal, or the like) to the identification unit 122 as described later.

(Identification Unit 122)

The identification unit 122 identifies the ground control point 200 detected by the detection unit 121. For example, the identification unit 122 identifies the ground control point 200 detected from the captured image (in other words, specifies the ID of the ground control point 200) by comparing information regarding the feature of the ground control point 200 in the captured image provided by the detection unit 121 with information regarding the feature of each ground control point 200 stored in the storage unit 160 in advance, or the like. For example, the identification unit 122 identifies the ground control point 200 detected from the captured image by recognizing the color, shape, or size of the ground control point 200 in the captured image, or a combination thereof.

Furthermore, the identification unit 122 may identify the ground control point 200 by analyzing information included in the wireless signal provided by the detection unit 121 and acquiring the ID of the ground control point 200 from the signal. The identification unit 122 provides information regarding the identification result of the ground control point 200 to the control unit 130 as described later.

(Control Unit 130)

The control unit 130 controls the flight of the UAV 100 on the basis of the information regarding the identification result of the ground control point 200 provided by the identification unit 122. For example, the control unit 130 generates a control signal in order to implement the flight operation associated with the ID of the ground control point 200, and provides the signal to the drive control unit 140 as described later. Furthermore, in a case where the ground control point 200 functions as the target pass point, the control unit 130 determines that the target pass point corresponding to the ground control point 200 has been passed, and performs the flight control toward the next target pass point. Furthermore, when the own device is flying (floating) near the ground surface (for example, immediately after takeoff or immediately before landing), by using the ground location information of the ground control point 200 and the location information of the own device obtained by the GNSS receiver mounted on the own device in accordance with the flight altitude, the control unit 130 changes both weights to calculate the location of the own device, and performs the flight control on the basis of a calculation result.

Note that the timing at which the control unit 130 performs the control is arbitrary. For example, the control unit 130 may perform the above control immediately after the ground control point 200 is identified, or the control unit 130 may perform the above control at the timing the identified ground control point 200 appears with a predetermined size in a predetermined area in the captured image (for example, at the substantial center of the captured image). Furthermore, the control unit 130 may control the flight of the UAV 100 such that the identified ground control point 200 appears with a predetermined size in a predetermined area in the captured image, and may perform the flight control corresponding to the ground control point 200 at the timing these conditions are satisfied. With this control, the timing of the flight control of the UAV 100 is defined in detail on the basis of the location relationship between the UAV 100 and the ground control point 200. Note that the above control is merely one example, and details of the control by the control unit 130 may be changed as appropriate.

Furthermore, details of the flight control in a case where a plurality of ground control points 200 is simultaneously identified (for example, in a case where a plurality of ground control points 200 appears in the captured image, or the like) are arbitrary. For example, in a case where a plurality of ground control points 200 is identified simultaneously, the control unit 130 may not perform the flight control corresponding to each ground control point 200. Furthermore, the control unit 130 may not perform each flight control in a case where the flight control corresponding to the plurality of ground control points 200 is inconsistent with each other (for example, “takeoff” and “landing” or the like). The control unit 130 may perform each flight control only in a case where the flight control is not inconsistent with each other (for example, “takeoff” and “left turn” or the like). Furthermore, after performing the flight control on the basis of the ground control point 200 identified earlier, the control unit 130 may ignore the ground control point 200. With this control, in a case where some other ground control point 200 is also identified thereafter, the control unit 130 can perform the flight control on the basis of the other ground control point 200.

(Drive Control Unit 140)

The drive control unit 140 controls the flight mechanism 150 as described later in accordance with the control by the control unit 130. More specifically, the drive control unit 140 generates a control signal for driving an actuator or the like on the basis of the control signal provided from the control unit 130, and provides the flight mechanism 150 with the signal. Note that the above control is merely one example, and details of the control by the drive control unit 140 may be changed as appropriate.

(Flight Mechanism 150)

The flight mechanism 150 is a configuration to fly the UAV 100, and includes, for example, an actuator, a motor, a propeller, or the like (not shown). The flight mechanism 150 performs driving in accordance with the control signal provided by the drive control unit 140 to fly the UAV 100.

(Storage Unit 160)

The storage unit 160 stores various pieces of information. For example, the storage unit 160 stores information such as the location information of the UAV 100, various pieces of setting information used for the flight of the UAV 100 (information regarding the speed setting or altitude setting of the UAV 100, the target pass point, or the like), information regarding the feature of each ground control point 200, or information regarding the flight control corresponding to the ID of the ground control point 200. Note that these pieces of information are merely one example, and the information stored by the storage unit 160 is arbitrary. For example, the storage unit 160 may store programs, parameters, or the like used by each functional configuration of the UAV 100.

(Functional Configuration of the Ground Control Point 200)

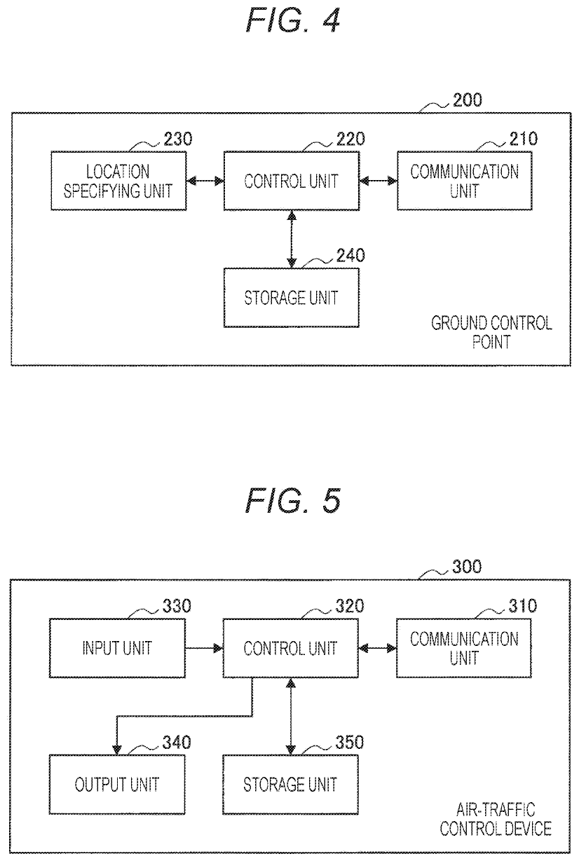

The functional configuration of the UAV 100 according to the present embodiment has been described above. Subsequently, with reference to FIG. 4, the functional configuration of the ground control point 200 according to the present embodiment will be described. FIG. 4 is a block diagram showing one example of the functional configuration of the ground control point 200 according to the present embodiment.

As shown in FIG. 4, the ground control point 200 according to the present embodiment includes a communication unit 210, a control unit 220, a location specifying unit 230, and a storage unit 240. The following describes each functional configuration.

(Communication Unit 210)

The communication unit 210 is a functional configuration to perform communication with an external device such as the UAV 100 or the air-traffic control device 300. For example, by performing wireless communication with the UAV 100 or the air-traffic control device 300, the communication unit 210 shares the ID of the own device with the UAV 100 or the air-traffic control device 300, or shares the location information of the own device specified by the location specifying unit 230 as described later with the UAV 100 or the air-traffic control device 300. Note that the above communication is merely one example, and contents of the communication by the communication unit 210 may be changed as appropriate. For example, in a case where the ground control point 200 is displayed electronically, the communication unit 210 may receive information regarding the sign to display from an external device.

(Control Unit 220)

The control unit 220 comprehensively controls the processing of the ground control point 200. For example, the control unit 220 specifies the location of the own device (latitude, longitude, altitude, or the like) by controlling the location specifying unit 230 as described later. Furthermore, the control unit 220 implements the communication processing by controlling the communication unit 210. Note that the above control is merely one example, and details of the control by the control unit 220 may be changed as appropriate.

(Location Specifying Unit 230)

The location specifying unit 230 specifies the location of the own device. More specifically, the location specifying unit 230 includes an antenna and the GNSS receiver, and specifies the location of the own device (latitude, longitude, altitude, or the like) by receiving radio signals from the GNSS satellites using the antenna, extracting GNSS observation data from the radio signals by using the GNSS receiver, and performing positioning processing by a single positioning method using the data.

(Storage Unit 240)

The storage unit 240 stores various pieces of information. For example, the storage unit 240 stores the location information of the own device or the like specified by the single positioning method. Note that the information is merely one example, and the information stored by the storage unit 240 is arbitrary. For example, the storage unit 240 may store programs, parameters, or the like used by each functional configuration of the ground control point 200.

(Functional Configuration of the Air-Traffic Control Device 300)

The functional configuration of the ground control point 200 according to the present embodiment has been described above. Subsequently, with reference to FIG. 5, the functional configuration of the air-traffic control device 300 according to the present embodiment will be described. FIG. 5 is a block diagram showing one example of the functional configuration of the air-traffic control device 300 according to the present embodiment.

As shown in FIG. 5, the air-traffic control device 300 according to the present embodiment includes a communication unit 310, a control unit 320, an input unit 330, an output unit 340, and a storage unit 350. The following describes each functional configuration.

(Communication Unit 310)

The communication unit 310 is a functional configuration to perform communication with an external device such as the UAV 100 or the ground control point 200. For communication with the UAV 100, for example, the communication unit 310 transmits various pieces of setting information used for the flight of the UAV 100 (information regarding the speed setting or altitude setting of the UAV 100, the target pass point, or the like) to the UAV 100, or receives the information regarding the flight status of the UAV 100 from the UAV 100. Furthermore, the communication unit 310 performs wireless communication with the ground control point 200 to receive the ID or location information of the ground control point 200, or the like. Note that the above communication is merely one example, and contents of the communication may be changed as appropriate. The communication unit 310 provides the received information to the control unit 320 as described later.

(Control Unit 320)

The control unit 320 comprehensively controls the processing of the air-traffic control device 300. For example, the control unit 320 makes various settings used for the flight of the UAV 100 (speed setting or altitude setting of the UAV 100, setting of the target pass point, or the like) on the basis of a user operation, and provides the setting information to the UAV 100 via the communication unit 310. Note that the control by the control unit 320 is not limited to the above control. For example, the control unit 320 may provide the user with various pieces of information by controlling the output unit 340 as described later.

(Input Unit 330)

The input unit 330 obtains input by the user. For example, the input unit 330 includes an input mechanism such as a touch panel, a keyboard, a mouse, or a button. In a case where the user performs various operations on such an input mechanism, the input unit 330 generates input information on the basis of the operations and provides the input information to the control unit 320. Note that the input mechanism provided in the input unit 330 and details of the input are arbitrary.

(Output Unit 340)

The output unit 340 controls various outputs. For example, the output unit 340 includes an output mechanism such as a display, a speaker, or a lamp, and displays various pieces of information on the display on the basis of the control signal from the control unit 320, or generates various sounds by the speaker. Furthermore, the output unit 340 may include a movable portion, and may move the portion in various manners on the basis of the control signal from the control unit 320. Note that the output mechanism provided in the output unit 340 and details of the output are arbitrary.

(Storage Unit 350)

The storage unit 350 stores various pieces of information. For example, the storage unit 350 stores information such as information regarding the flight status of the UAV 100, various pieces of setting information used for the flight of the UAV 100 (information regarding the speed setting or altitude setting of the UAV 100, the target pass point, or the like), or the location information of the ground control point 200. Note that these pieces of information are merely one example, and the information stored by the storage unit 350 is arbitrary. For example, the storage unit 350 may store programs, parameters, or the like used by each functional configuration of the air-traffic control device 300.

### 4. OPERATION OF THE DEVICES

The functional configuration of each device according to the present embodiment has been described above. Subsequently, the operation of each device according to the present embodiment will be described.

Note that the following will describe, though not exclusively, a case where the flight control of the UAV 100 is performed on the basis of the ground control point 200 in the captured image as one example. More specifically, the operation described below may be applied to a case where the ground control point 200 is detected and identified on the basis of a wireless signal, and the flight control of the UAV 100 is performed.

(4-1. Flight Control of the UAV 100 Based on Identification of the Ground Control Point 200)

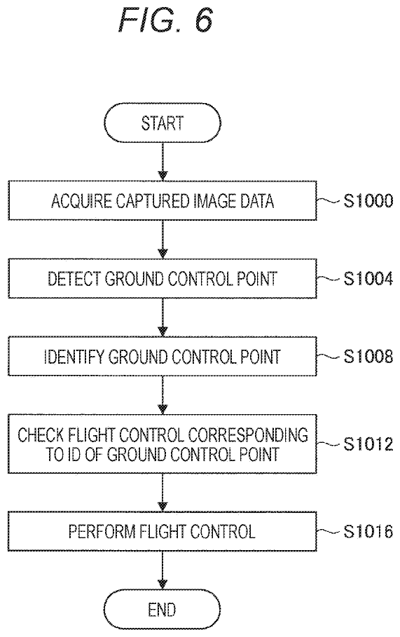

First, with reference to FIG. 6, one example of the flight control of the UAV 100 based on the identification of the ground control point 200 will be described. FIG. 6 is a flowchart showing one example of the flight control of the UAV 100 based on the identification of the ground control point 200.

In step S1000, the camera 101 captures the ground surface, and the sign processing unit 120 of the UAV 100 acquires the captured image data captured by the camera 101. In step S1004, the detection unit 121 detects the ground control point 200 from inside the captured image by analyzing the captured image data. In step S1008, the identification unit 122 identifies the ground control point 200 on the basis of the feature of the detected ground control point 200 or the like (specifies the ID of the ground control point 200).

Then, the control unit 130 checks details of the flight control corresponding to the ID of the ground control point 200 in step S1012, and performs the flight control in step S1016, whereby the processing ends.

With the above operation, the UAV 100 can control the flight of the own device autonomously without being always operated by the user. Note that by repeating the above operation, the UAV 100 can continue to control the flight of the own device continuously.

(4-2. Flight Control of the UAV 100 in a Case where the Ground Control Point 200 Functions as the Target Pass Point)

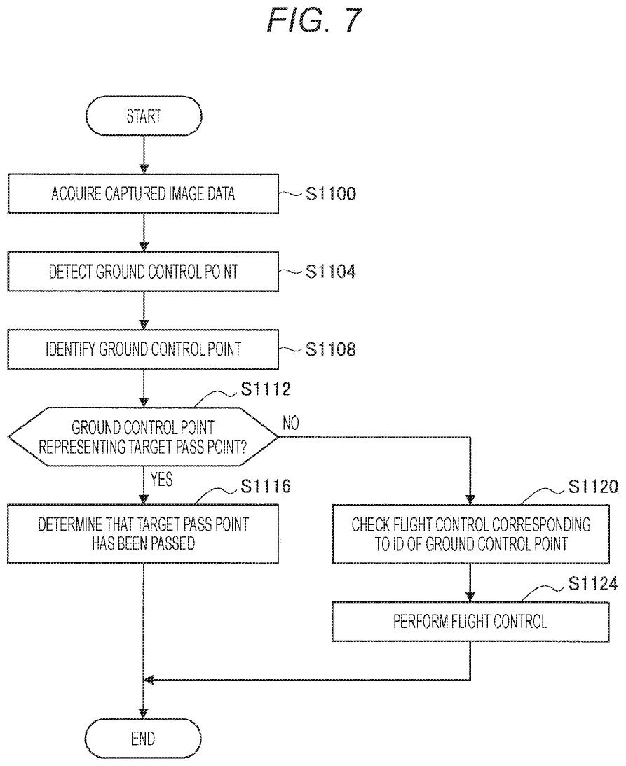

Subsequently, with reference to FIG. 7, one example of the flight control of the UAV 100 in a case where the ground control point 200 functions as the target pass point will be described. FIG. 7 is a flowchart showing one example of the flight control of the UAV 100 in a case where the ground control point 200 functions as the target pass point.

The operation of steps S1100 to S1108 is the same as the operation of steps S1000 to S1008 of FIG. 6, and thus descriptions will be omitted. In a case where the ground control point 200 identified by the identification unit 122 of the UAV 100 is a sign representing the target pass point (step S1112/Yes), in step S1116, the control unit 130 determines that the ground control point 200 has been passed by having identified the target pass point, and the processing ends (performs control to fly toward the next target pass point). In a case where the ground control point 200 identified by the identification unit 122 is not a sign representing the target pass point (step S1112/No), the control unit 130 checks details of the flight control corresponding to the ID of the ground control point 200 in step S1120, and performs the flight control in step S1124, whereby the processing ends.

The above operation will increase the possibility that the UAV 100 can pass the target pass point. In other words, in a case where the ground control point is installed before the target pass point and meaning of the ID is set as “fly at a lower speed (decrease the speed)”, the UAV 100 flies at a low speed before the target pass point, thereby increasing the possibility that the UAV 100 can pass the airspace that is set as the target pass point. Furthermore, the UAV 100 cannot pass the target pass point in some cases due to the influence of wind or settings of the target pass point by the air-traffic control device 300 (in a case where the target pass point is small, a case where each target pass point is set such that a turn exceeding turning performance of the UAV 100 is required, or the like). However, the ground control point 200 functions as the target pass point, thereby decreasing the possibility that the UAV 100 cannot pass the target pass point due to these factors.

(4-3. Flight Control of the UAV 100 Near the Ground Surface)

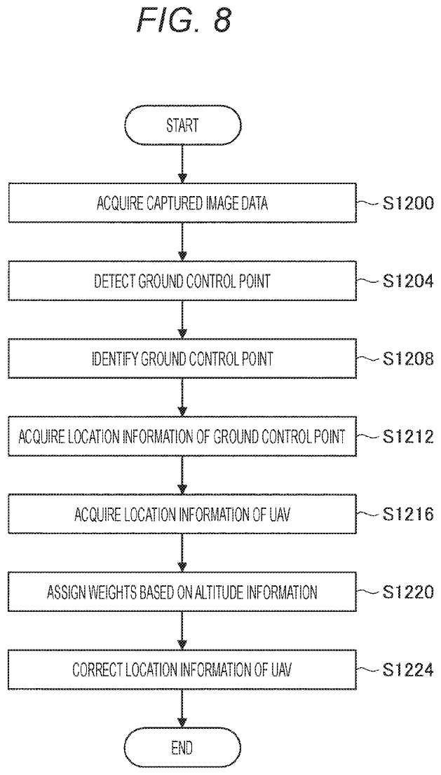

Subsequently, with reference to FIG. 8, one example of the flight control of the UAV 100 near the ground surface (for example, an operation in a case where the UAV 100 makes a takeoff or landing) will be described. FIG. 8 is a flowchart showing one example of the flight control of the UAV 100 near the ground surface.

In step S1200, the camera 101 captures the ground control point 200 installed at a point where the UAV 100 makes a takeoff or landing, and the sign processing unit 120 of the UAV 100 acquires the captured image data captured by the camera 101. In step S1204, the detection unit 121 detects the ground control point 200 from inside the captured image by analyzing the captured image data. In step S1208, the identification unit 122 identifies the ground control point 200 on the basis of the feature of the detected ground control point 200 or the like (specifies the ID of the ground control point 200).

In step S1212, the control unit 130 acquires the location information of the ground control point 200 by wireless communication with the ground control point 200 or the like. In step S1216, the control unit 130 acquires the location information of the own device (latitude, longitude, altitude, or the like) by using the GNSS receiver mounted on the own device. Then, in step S1220, the control unit 130 assigns weights to the location information of the ground control point 200 and the location information obtained by using the GNSS receiver mounted on the own device in accordance with the flight altitude of the own device, whereby the control unit 130 corrects the location information of the own device in step S1224.

With the above operation, even when the UAV 100 is flying (floating) near the ground surface, the flight of the UAV 100 (attitude or the like) becomes stable because the fluctuation of the location information of the own device becomes smaller.

With the above operation, in particular, in a case where the UAV 100 is a VTOL or multicopter-type flying body, the attitude of the UAV 100 during takeoff can be further stabilized. Furthermore, even in a case where the UAV 100 is a flying body with a high moving speed, such as an aircraft-type flying body (aircraft or VTOL), the above operation can improve the difficulty of passing the target pass point.

### 5. HARDWARE CONFIGURATION

The embodiment of the present disclosure has been described above. Information processing such as the above flight control is implemented by cooperation between software and hardware described below.

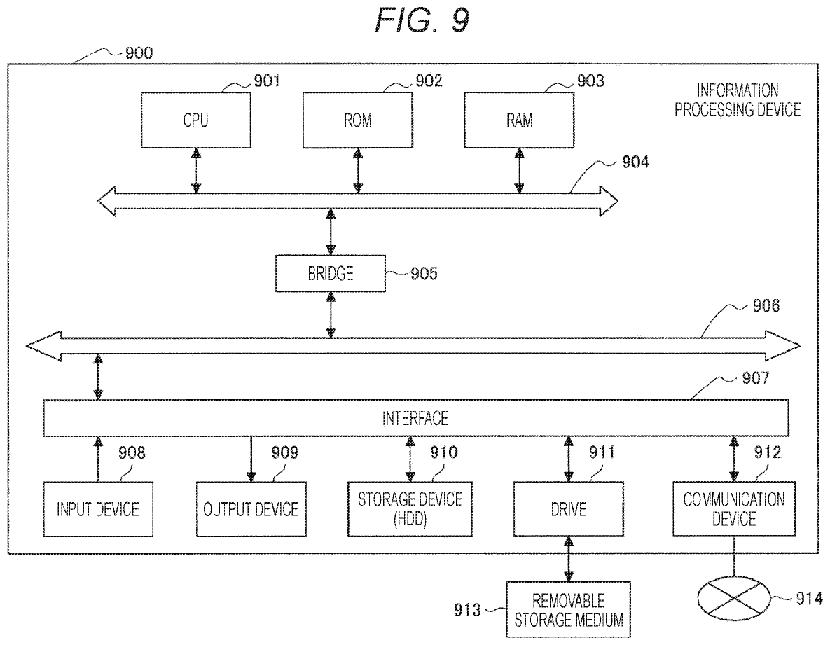

FIG. 9 is a diagram showing a hardware configuration of an information processing device 900 that embodies the UAV 100, the ground control point 200, or the air-traffic control device 300 according to the present embodiment. The information processing device 900 includes a central processing unit (CPU) 901, a read only memory (ROM) 902, a random access memory (RAM) 903, and a host bus 904. Furthermore, the information processing device 900 includes a bridge 905, an external bus 906, an interface 907, an input device 908, an output device 909, a storage device (HDD) 910, a drive 911, and a communication device 912.

The CPU 901 functions as an arithmetic processing device and a control device, and controls the overall operation in the UAV 100, the ground control point 200, or the air-traffic control device 300 in accordance with various programs. Furthermore, the CPU 901 may be a microprocessor. The ROM 902 stores programs, calculation parameters, or the like used by the CPU 901. The RAM 903 temporarily stores programs used in the execution of the CPU 901 and parameters or the like that appropriately change in the execution. These are mutually coupled by the host bus 904 including a CPU bus or the like. Respective functions of the sign processing unit 120, the control unit 130, and the drive control unit 140 of the UAV 100, the location specifying unit 230 and the control unit 220 of the ground control point 200, and the control unit 320 of the air-traffic control device 300 are implemented by cooperation of the CPU 901, the ROM 902, and the RAM 903.

The host bus 904 is coupled to the external bus 906 such as a peripheral component interconnect/interface (PCI) bus via the bridge 905. Note that the host bus 904, the bridge 905, and the external bus 906 do not necessarily have to be separated, and these functions may be implemented in one bus.

The input device 908 includes an input unit for the user to input information such as a mouse, a keyboard, a touch panel, a button, a microphone, a switch, or a lever, an input control circuit that generates an input signal on the basis of an input by the user and outputs the input signal to the CPU 901, and the like. By operating the input device 908, the user who uses the UAV 100, the ground control point 200, or the air-traffic control device 300 can input various data to each device or give instructions to perform a processing operation. Functions of the input unit 330 of the air-traffic control device 300 are implemented by the input device 908 (functional configuration corresponding to the input device 908 in the UAV 100 and the ground control point 200 is not shown).

The output device 909 includes, for example, a display device such as a cathode ray tube (CRT) display device, a liquid crystal display (LCD) device, an organic light emitting diode (OLED) device, or a lamp. Moreover, the output device 909 includes a voice output device such as a speaker or a headphone. The output device 909 outputs, for example, reproduced content. Specifically, the display device displays various pieces of information such as reproduced video data as text or images. Meanwhile, the voice output device converts the reproduced voice data or the like into voice and outputs the voice. Functions of the output unit 340 of the air-traffic control device 300 are implemented by the output device 909 (functional configuration corresponding to the output device 909 in the UAV 100 and the ground control point 200 is not shown).

The storage device 910 is a device for storing data and configured as one example of the storage unit 160 of the UAV 100, the storage unit 240 of the ground control point 200, or the storage unit 350 of the air-traffic control device 300 according to the present embodiment. The storage device 910 may include a storage medium, a recording device that records data in the storage medium, a reading device that reads data from the storage medium, an erasing device that erases data recorded in the storage medium, and the like. The storage device 910 includes, for example, a hard disk drive (HDD). This storage device 910 drives the hard disk and stores programs executed by the CPU 901 or various data.

The drive 911 is a reader writer for a storage medium, and is incorporated in or externally attached to the UAV 100, the ground control point 200, or the air-traffic control device 300. The drive 911 reads information recorded on a mounted removable storage medium 913 such as a magnetic disk, optical disk, magneto-optical disk, or semiconductor memory, and outputs the information to the RAM 903. Furthermore, the drive 911 can also write information in the removable storage medium 913.

The communication device 912 is a communication interface including, for example, a communication device for connecting to a communication network 914 or the like. Respective functions of the communication unit 110 of the UAV 100, the communication unit 210 of the ground control point 200, or the communication unit 310 of the air-traffic control device 300 are implemented by the communication device 912.

### 6. CONCLUSION

As described above, the control device, the control method, and the program according to the present disclosure identify the ground control point 200 installed on the ground on the basis of information acquired by the UAV 100, and control the flight of the UAV 100 in accordance with a result of the identification. For example, by analyzing the captured image captured by the camera 101 or performing wireless communication with the ground control point 200 during flight, the UAV 100 detects and identifies the ground control point 200, and controls the flight of the own device on the basis of the ID of the ground control point 200. This allows the UAV 100 to control the flight of the own device more appropriately.

Furthermore, the ground control point 200 also functions as the target pass point, thereby increasing the possibility that the UAV 100 can pass the target pass point. Moreover, when flying (floating) near the ground surface (for example, immediately after takeoff or immediately before landing), the UAV 100 can implement stable flight by performing control using the ground location information of the identified ground control point 200.

The preferred embodiment of the present disclosure has been described in detail above with reference to the accompanying drawings, but the technical scope of the present disclosure is not limited to such an example. It is obvious that persons of ordinary skill in the technical field of the present disclosure can conceive various modifications or alterations within the scope of the technical idea described in the claims, and it is of course understood that these also fall within the technical scope of the present disclosure.

For example, each step shown in each flowchart above does not necessarily have to be processed on a time-series basis according to the order described as the flowchart. In other words, each step may be processed in order different from the order described as the flowchart or in parallel.

Furthermore, part of the functional configuration of the UAV 100, the ground control point 200, or the air-traffic control device 300 may be provided in an external device as appropriate. Furthermore, part of the function of the UAV 100 may be embodied by the control unit 130. For example, the control unit 130 may embody part of the functions of the communication unit 110, the sign processing unit 120, or the drive control unit 140. Furthermore, part of the function of the ground control point 200 may be embodied by the control unit 220. For example, the control unit 220 may embody part of the function of the communication unit 210 or the location specifying unit 230. Furthermore, part of the function of the air-traffic control device 300 may be embodied by the control unit 320. For example, the control unit 320 may embody part of the functions of the communication unit 310, the input unit 330, or the output unit 340.

Furthermore, as described above, the present disclosure can be used in various systems, and in a case where the present disclosure is used in a land survey system, the ground control point 200 may be used not only as a sign for the flight control of the UAV 100, but also as a sign for land survey.

Furthermore, the effects described in the present specification are merely descriptive or illustrative and not restrictive. That is, the technique according to the present disclosure can produce other effects obvious to those skilled in the art from the description in the present specification, in addition to or instead of the effects described above.

Note that the following configurations also belong to the technical scope of the present disclosure.

(1)

A control device including:
an identification unit configured to identify a sign installed on a ground on the basis of information acquired by an UAV; and
a control unit configured to control a flight of the UAV in accordance with the identification.

(2)

The control device according to the (1), in which
the identification unit performs the identification during the flight of the UAV.

(3)

The control device according to the (1) or (2), in which
the control unit performs the control corresponding to the sign.

(4)

The control device according to the (3), in which
the sign functions as a target pass point for the UAV, and
the control unit determines success or failure in passing the target pass point by the UAV in accordance with the identification.

(5)

The control device according to the (3), in which
the control unit performs the control by using location information of the sign together.

(6)

The control device according to the (5), in which
the control unit determines location information of the UAV by using the location information of the sign.

(7)

The control device according to the (6), in which
the control unit corrects the location information of the UAV by changing a weight of each of the location information of the UAV and the location information of the sign determined on the basis of a GNSS signal received by the UAV in accordance with altitude of the UAV.

(8)

The control device according to any one of the (1) to (7), in which
the information is information acquired in a case where a separation distance between the UAV and the sign is equal to or less than a predetermined distance.

(9)

The control device according to the (8), in which
the information is captured image data in which the sign aerially captured from the UAV appears.

(10)

The control device according to the (8), in which
the information is signal information acquired by the UAV by wireless communication with the sign.

(11)

The control device according to any one of the (1) to (10), in which
the identification unit performs the identification on the basis of color of the sign.

(12)

The control device according to any one of the (1) to (11), in which
the identification unit performs the identification on the basis of a shape of the sign.

(13)

A control method to be executed by a computer, the control method including:
performing identification of a sign installed on a ground on the basis of information acquired by a UAV; and
performing control of a flight of the UAV in accordance with the identification.

(14)

A program for causing a computer to execute:
performing identification of a sign installed on a ground on the basis of information acquired by a UAV; and
performing control of a flight of the UAV in accordance with the identification.

### REFERENCE SIGNS LIST

100 UAV
101 Camera
110 Communication unit
120 Sign processing unit
121 Detection unit
122 Identification unit
130 Control unit
140 Drive control unit
150 Flight mechanism
160 Storage unit
200 Ground control point
210 Communication unit
220 Control unit
230 Location specifying unit
240 Storage unit
300 Air-traffic control device
310 Communication unit
320 Control unit
330 Input unit
340 Output unit
350 Storage unit

1. A control device comprising:
an identification unit configured to identify a sign installed on a ground on a basis of information acquired by an UAV; and
a control unit configured to control a flight of the UAV in accordance with the identification.

2. The control device according to claim 1, wherein
the identification unit performs the identification during the flight of the UAV.

3. The control device according to claim 1, wherein
the control unit performs the control corresponding to the sign.

4. The control device according to claim 3, wherein
the sign functions as a target pass point for the UAV, and
the control unit determines success or failure in passing the target pass point by the UAV in accordance with the identification.

5. The control device according to claim 3, wherein
the control unit performs the control by using location information of the sign together.

6. The control device according to claim 5, wherein
the control unit determines location information of the UAV by using the location information of the sign.

7. The control device according to claim 6, wherein
the control unit corrects the location information of the UAV by changing a weight of each of the location information of the UAV and the location information of the sign determined on a basis of a GNSS signal received by the UAV in accordance with altitude of the UAV.

8. The control device according to claim 1, wherein
the information is information acquired in a case where a separation distance between the UAV and the sign is equal to or less than a predetermined distance.

9. The control device according to claim 8, wherein
the information is captured image data in which the sign aerially captured from the UAV appears.

10. The control device according to claim 8, wherein
the information is signal information acquired by the UAV by wireless communication with the sign.

11. The control device according to claim 1, wherein
the identification unit performs the identification on a basis of color of the sign.

12. The control device according to claim 1, wherein
the identification unit performs the identification on a basis of a shape of the sign.

13. A control method to be executed by a computer, the control method comprising:
performing identification of a sign installed on a ground on a basis of information acquired by a UAV; and
performing control of a flight of the UAV in accordance with the identification.

14. A program for causing a computer to execute:
performing identification of a sign installed on a ground on a basis of information acquired by a UAV; and
performing control of a flight of the UAV in accordance with the identification.
